(19) United States
(12) Patent Application Publication
(10) Pub. No.: US 2012/0111162 A1
(43) Pub. Date: May 10, 2012

(54) DEVICE AND METHOD FOR PRODUCING MONOAXIAL OR MULTIAXIAL SCRIMS

(75) Inventors: Astrid KIRCHBERG, Chemnitz (DE); Wolfram KRETZSCHMAR, Chemnitz (DE); Frank VETTERMANN, Jahnsdorf (DE); Klaus WIEDENHOEFT, Chemnitz (DE); Matthias THIEME, Chemnitz (DE)

(73) Assignee: KARL MAYER MALIMO TEXTILMASCHINENFABRIK GMBH, Chemnitz (DE)

(21) Appl. No.: 13/037,913

(22) Filed: Mar. 1, 2011

(30) Foreign Application Priority Data
Nov. 4, 2010 (EP) 10 014 280.1

(51) Int. Cl. B26D 7/06; B26D 7/27

(52) U.S. Cl. 83/23; 83/112

(57) ABSTRACT

Device and method for producing scrims of fiber bands. The device includes a dispensing arrangement structured and arranged for dispensing fiber bands, a severing device structured and arranged for cutting the fiber bands to a cut length and comprising a knife with a cutting edge displaceable in a direction of an extension of the cutting edge, a conveyor device structured and arranged for conveying at least one layer of fiber bands to a bonding device, and a transport device structured and arranged to deposit the cut length fiber bands onto the conveyor device.

### CROSS-REFERENCE TO RELATED APPLICATIONS

The present application claims priority under 35 U.S.C. §119 of European Patent Application No. 10 014 280.1, filed on Nov. 4, 2010, the disclosure of which is expressly incorporated by reference herein in its entirety.

### BACKGROUND OF THE INVENTION

1. Field of the Invention

The invention relates to a device for producing monoaxial or multiaxial scrims of fiber bands with a dispensing arrangement for dispensing the fiber bands, a severing device for cutting the fiber bands to length, a conveyor device for conveying at least one layer of fiber bands arranged next to one another to a bonding device, and a transport device for depositing the cut to length fiber bands on the conveyor device.

Furthermore, the invention relates to a method for producing monoaxial or multiaxial scrims in which a fiber band with a predetermined length is removed from a dispensing arrangement, the fiber band is severed, a cut to length fiber band is placed next to fiber bands already deposited on a conveyor device, and the fiber bands lying next to one another are bonded.

2. Discussion of Background Information

In the production of a monoaxial scrim, filaments or other thread-like structures are laid next to one another in a large number so that they form a flat material. This flat material is then fed for bonding, for example, in an active area of a knitting machine in order to connect the filaments or thread-like structures to one another. In the case of a multiaxial scrim, this operation is supplemented by laying several layers of this type of filaments or thread-like structures on top of one another in different directions.

In order to respectively form a layer of filaments lying next to one another, it is known to transport the filaments in the desired direction via the conveyor device, then to carry out a shift in the direction of movement of the conveyor device and then to guide the filaments back again in the opposite direction. An endless laying of the filaments is thus possible.

However, some materials cannot be laid in this manner or only under unfavorable conditions. In the case of these materials, for example, carbon fibers, another method is selected. Band-shaped sheets are formed from the filaments or other thread-like structures. In order to simplify the following explanation, these filament sheets are referred to as “fiber bands” for short. These fiber bands are removed from the dispensing arrangement, wherein the dispensing arrangement can provide a certain conveying power.

When a fiber band of this type with a desired length has been removed from the dispensing arrangement, it is severed. The fiber band thus cut to length is then placed on the conveyor device. The conveyor device is moved in order to make room for the next fiber band and the operation is repeated.

The principle of producing monoaxial or multiaxial scrims with different laying types is described in DE 10 2007 024 124 B3, the disclosure of which is expressly incorporated by reference herein in its entirety. A description of the described mode of operation can also be found in EP 1 512 784 A1, the disclosure of which is expressly incorporated by reference herein in its entirety.

When laying the fiber bands, it is important that each fiber band has a uniform tension over its width. Differences in tension would lead to the formation of waves, which would have an unfavorable effect on the appearance of the monoaxial or multiaxial scrim. Furthermore, strength problems could result during later use of a monoaxial or multiaxial scrim of this type.

In recent years, the width of the fiber bands that can be produced and laid on the conveyor device has constantly increased. The wider the fiber bands, the greater the risk that differences in tension will result in the fiber bands during severing.

### SUMMARY OF THE INVENTION

Embodiments of the invention keep differences in tension during severing as slight as possible.

According to embodiments, a device of the type mentioned at the outset includes a severing device having a knife with a cutting edge that is displaceable in the direction of the extension of the cutting edge.

With a knife of this type, a dragging cut can be performed which acts on the entire width of the fiber band simultaneously. Therefore, in contrast to a scissor-like cut or a cut in which a knife is guided through the fiber band in the width direction, there are no regions of the fiber band in the width direction that are still connected while other regions have already been severed. For this purpose, of course, the cutting edge has a length that is greater than the width of the fiber band, which is easily possible. Particularly, the fiber band is severed in the direction of its thickness. As the thickness of a fiber band is much smaller than its width, the severing can be carried out in a very short time and so that a risk of differences in tension in the fiber band is virtually non-existent.

Preferably, the cutting edge runs parallel to a plane in which a surface of the fiber bands lies into which the cutting edge plunges. The fiber band and the cutting edge are therefore aligned parallel to one another so that the cutting edge can impinge on the fiber band completely in the width direction.

Preferably, the knife is coordinated with the fiber bands such that the fiber bands can be severed by a single movement of the cutting edge. Thus, the knife has a length that is larger than the width of the fiber bands such that a reserve remains that is utilized for the cutting movement. Since the severing operation occurs through a movement of the knife in a single direction, no tension differences can be caused by a change of direction of the knife.

It may be preferable that the knife is embodied or formed as a rotary knife band. A rotating knife band can be equipped with a virtually endlessly long cutting edge so that a sufficiently large length is available for the cutting operation. Moreover, the knife band can be driven in a single direction. In this regard, a rotary drive can preferably be used which acts, for example, on a deflector roll for the knife band. This makes the drive of the knife relatively simple.

Preferably, a mating profile is assigned to the knife, so that the knife and the mating profile can be moved relative to one another perpendicular to the cutting direction. For example, the mating profile can be moved towards the knife so that the mating profile presses the fiber band onto the moving knife in order to sever the fiber band.

It is preferred hereby that the mating profile has a groove into which the knife plunges. The groove ensures that the fiber band during the cutting or severing operation is held as it were taut between the two flanks of the groove. In the short taut section, the cutting edge of the knife can then plunge in order to sever the fiber band.

Preferably, in addition to the mating profile on the side of the conveyor device a dropper is arranged, which presses the fiber band into a holding device on the conveyor device. The holding device can be embodied or formed, for example, as has been described in EP 1 512 784 A1. Thus, the attaching operation of the rear end of the fiber band and the severing operation can be combined. This can have several advantages, such as no additional holding device is needed for the rear end of the fiber band, i.e., the end adjacent to the severing point of the fiber band cut to length and time can be saved when the two operations are combined with one another.

Preferably, the dropper and the mating profile can be attached to a common holder. In embodiments, only the holder is moved in order to allow the dropper and the mating profile to act jointly on the fiber band.

Preferably, the dropper and the mating profile are connected to one another on the holder via a spring arrangement and can be moved relative to one another. With this embodiment, not only can the dropper and the mating profile be moved together, it is also possible, e.g., to move the mating profile further when the dropper has already come to abutment at the conveyor device at a stop. The spring arrangement here provides a certain motion reserve that ensures that the two elements, i.e., the mating profile and dropper, can be re-aligned to one another as is desired even with a relative movement of dropper and mating profile at the end of a movement of the holder.

Preferably, an elastically yielding bearing surface is arranged in addition to the knife on the side of the dispensing arrangement. When the fiber band is to be severed, it can first be compressed on the bearing surface. When a certain compressive force has been achieved, then the bearing surface moves jointly with the fiber band towards the knife (or the knife moves towards the fiber band). In this manner, the thickness of the fiber band that is to be severed is reduced and the cutting operation can be further accelerated.

According to embodiments, a method of the type mentioned at the outset includes severing the fiber band with a cutting edge of a knife guided through the fiber band in a thickness direction with a dragging cut.

Through this dragging cut to sever the fiber band over the entire width at the same time, no tension differences can build up or result inside the width of the fiber band.

Preferably the cut is performed with a movement in a single direction. Even a change of direction of the cutting edge then cannot lead to tension differences inside the width of the fiber band.

Preferably, the cut is performed with an uninterrupted movement. Thus, the fiber band is severed over its thickness under constant conditions so that tension differences cannot be hereby introduced into the fiber band either.

It is also advantageous if the fiber band is pressed in the direction towards the knife and at the same time the fiber band is pressed onto a holding device on the conveyor device. In this case, the severing of the fiber band can be combined with the attachment of the fiber band to the conveyor device. Of course, a certain attachment of the fiber band to the conveyor device must be achieved before a complete severing of the fiber band has occurred. However, this can be taken into account by a coordinated movement towards the holding device and towards the knife.

It may also be preferable if the fiber band is compressed during cutting to reduce its thickness. In this case, the time required for the complete severing of the fiber band may be minimized.

Embodiments of the invention are directed to a device for producing scrims of fiber bands. The device includes a dispensing arrangement structured and arranged for dispensing fiber bands, a severing device structured and arranged for cutting the fiber bands to a cut length and comprising a knife with a cutting edge displaceable in a direction of an extension of the cutting edge, a conveyor device structured and arranged for conveying at least one layer of fiber bands to a bonding device, and a transport device structured and arranged to deposit the cut length fiber bands onto the conveyor device.

According to aspects of the embodiments, the scrims can be monoaxial or multiaxial scrims.

In accordance with other aspects, the at least one layer of fiber bands can include a plurality of the cut length fiber bands arranged next to one another.

Further, the cutting edge may be arranged to run in a plane parallel to a surface of the fiber bands into which the cutting edge is structured and arranged to be plunged.

According to still other aspects of the embodiments, relative movement between the knife and the fibers bands can be coordinated so that the fiber bands are severable by a single movement of the cutting edge.

According to embodiments of the present invention, the knife can include a rotary knife band.

According to further aspects of the embodiments of the invention, a mating profile may be assigned to the knife. The knife and the mating profile can be movable relative to one another in a direction perpendicular to a cutting direction. The mating profile may include a groove into which the knife is structured and arranged to be plunged. Further, a dropper can be arranged on a same side of the conveyor as the mating profile. The dropper can be structured and arranged to press the fiber band into a holding device of the conveyor device. The dropper and the mating profile may be attached to a common holder. Further, the dropper and the mating profile can be arranged for relative movement via a spring arrangement.

In accordance with other embodiments, a bearing surface can be arranged on a same side of the dispensing arrangement as the knife. The bearing surface may be an elastically yielding bearing surface.

Embodiments of the invention are directed to a method for producing one of monoaxial or multiaxial scrims. The method includes removing predetermined length of a fiber band with a dispensing arrangement, guiding a cutting edge of a knife through the fiber band in a thickness direction with a dragging cut to sever the fiber band to a cut length, placing the cut length fiber bands next to previously placed cut length fiber bands on a conveyor device, and bonding the fiber bands placed next to one another.

According to aspects of the embodiments of the instant invention, the dragging cut can be performed with a movement in a single direction. Further, the dragging cut can be performed with an uninterrupted movement.

According to further aspects of the embodiments, the method can include pressing the fiber band in a direction toward the knife and at the same time pressing the fiber band onto a holding device on the conveyor device.

In accordance with still yet other aspects of the embodiments of the present invention, the pressing of the fiber band toward the knife can results in a compression of a thickness of the fiber band. Further, the dragging cut can be performed while the thickness of the fiber band is compressed.

Embodiments of the invention are directed to a method for producing one of monoaxial or multiaxial scrims. The method includes drawing predetermined lengths of fiber band from a fiber band supply, simultaneously severing an entire width of the fiber band with a dragging cut to form fiber bands of a predetermined cut length, successively placing the predetermined cut length fiber bands next to one another on a conveyor device, and bonding the fiber bands placed next to one another.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates a device for producing monoaxial scrims before the severing of a fiber band;

FIG. 2 illustrates the device during severing; and

FIG. 3 illustrates an enlarged representation of a part of a severing device.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

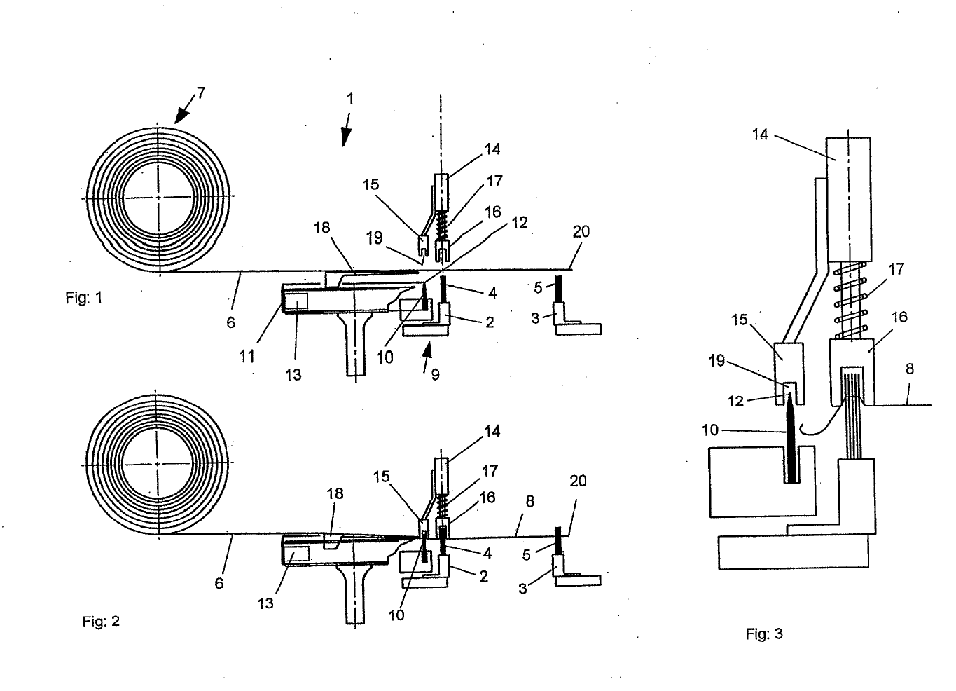

FIG. 1 shows in a very diagrammatic form a device 1 for producing a monoaxial scrim with a conveyor device, which has two transport chains 2 and 3, which can be moved perpendicular to the drawing plane. Transport chains 2 and 3 have needle arrangements 4 and 5, which serve as holding devices. Needle arrangements of this type are described, e.g., in EP 1 512 784 A1, however, it is understood that other holding devices can also be utilized without departing from the spirit and scope of the embodiments of the invention.

A fiber band 6 is removed from a dispensing arrangement 7. Dispensing arrangement 7 in the illustrated embodiment can be a reel from which fiber band 6 may be unwound. However, it is also understood that dispensing arrangement 7 can also be embodied or formed, for example, as shown in DE 10 2005 008 705 B3, or embodied or formed in a completely different manner without departing from the spirit and scope of the embodiments of the invention.

Fiber band 6, which can be a band-shaped filament sheet formed, e.g., of carbon fibers or glass fibers or filaments, is removed from dispensing arrangement 7 to a suitable extent so that it can bridge a distance between transport chains 2 and 3. Thereafter, a fiber band section 8 bridging this distance between transport chains 2 and 3 can then be severed from fiber band 6. To this end, a severing device 9 is provided, which is explained more fully below.

Severing device 9 has a knife 10, which is embodied or formed as a rotary knife. A leading portion or section of severing device 9 is arranged adjacent to transport chain 2 and reverse or trailing portion or section 11 of severing device 9 is guided at a distance transport chain 2.

Knife 10 has a cutting edge 12, which is positionable adjacent to fiber band 6. When knife 10 is moved, cutting edge 12 is moved with it. A drive 13 for knife 10, which is diagrammatically illustrated, can be embodied or formed as a rotary drive and act, e.g., on a deflector roll, over which a knife band forming knife 10 is guided.

For reasons of simplicity, the illustrated embodiment is described with reference to an embodiment in which severing device 9 is located or arranged on an “underside” of fiber band 6. Those ordinarily skilled in the art will recognize that the severing device 9 can also be located or arranged on a top or upper side of fiber band 6, which is opposite the underside.

A holder 14 can be arranged on the upper side of fiber band 6, and a mating profile 15 may be attached to holder 14. Mating profile 15 can be rigidly attached to holder 14. Further, a dropper 16 can be attached to holder 14, however, dropper 16 can be arranged in a moveable manner with respect to holder 14. Also, dropper 16 can be supported with a compression spring 17 with respect to holder 14.

An elastically yielding bearing surface 18 may be arranged on the underside of fiber band 6 to bear against fiber band 6 when holder 14 is moved toward fiber band 6. Moreover, this movement of holder 14 continues even after dropper 16 contacts fiber band 6, as shown in FIG. 2. Bearing surface 18 can be pressed downwards by fiber band 6 as fiber band 6 is acted on by downward moving mating profile 15. In this way, fiber band 6 can then be compressed in the thickness direction by the interaction with mating profile 15 and bearing surface 18. While the thickness of fiber band 6 is reduced, fiber band 6 can be more easily severed.

Mating profile 15 includes a groove 19 that is arranged so that knife 10 can plunge into groove 19 when fiber band 6. As mating profile 15 presses down on fiber band 6, a portion of fiber band 6 is stretched over the two flanks or edges of groove 19 so that cutting edge 12 of knife 10 can easily penetrate through fiber band 6.

The device 1 works as follows:

Fiber band 6 can be gripped with a gripper (not shown in further detail) and drawn out so that a front end 20 of fiber band 6 can be guided far enough over needle arrangement 5 on transport chain 3 to be pressed into needle arrangement 5. This situation is shown in FIG. 1.

As soon as front end 20 is drawn out to the condition illustrated in FIG. 1, holder 14 can be lowered in a direction toward fiber band 6. As a result, dropper 16 begins pressing fiber band 6 into needle arrangement 4 on transport chain 2. Another dropper (not shown) can be arranged to press front end 20 into needle arrangement 5 on transport chain 3. As holder 14 continues to move, fiber band 6 can be pressed onto bearing surface 18, which begins to deform under this pressure. It is noted that a yielding displacement of bearing surface 18 can also be referred to here as “deformation”). As holder 14 moves still further, dropper 16 may not be able to move further because it has come to bear against needle arrangement 4. However, because of the arrangement, spring 17 can be compressed to prevent a further downward movement of dropper 16, while mating profile 15 can continue moving towards knife 10 so that cutting edge 12 can be plunged into groove 19. In this manner, fiber band 6 may be severed, so that a fiber band section 8 cut to length is produced.

The gripper, mentioned above but not shown in further detail, now grips the end of the fiber band 6 still connected to the dispensing arrangement 7 and the operation starts over again.

The severing of fiber band 6 can be carried out with a dragging cut, wherein the knife 10 is moved in only one direction. Knife 10 is arranged with its cutting edge 12 parallel to the plane of fiber band 6 so that cutting edge 12 can sever fiber band 6 over entire width thereof simultaneously. This applies even when the fiber band 6 has a width larger than, e.g., several hundred mm. Therefore, during the severing, no regions of fiber band 6 with different tensions can result in the width direction, so that no tension differences are introduced into fiber band 6. Furthermore, the severing operation takes place relatively quickly because cutting edge 12 only needs a relatively short time to penetrate through the thickness of fiber band 6, which is reduced by the compression of fiber band 6.

As noted above, the arrangement of knife 10 on the underside of fiber band 6 as shown in the illustrated embodiment is not compulsory, i.e., knife 10 can also be arranged on the upper side of fiber band 6.

Knife 10 preferably moves parallel to a movement direction of transport chains 2 and 3. In this case, the material of fiber band 6 is utilized in the best possible way, even when fiber band 6 is guided at an angle unequal to 90° relative to the direction of movement of transport chains 2 and 3. This direction is also understood to be included under the term “width direction.”

However, it is also possible to move knife 10 in a different direction, e.g., at a right angle to the longitudinal direction of fiber band 6. This may be advantageous in that the cutting length is shorter.

While the foregoing discussion generally relates to process steps for producing a monoaxial scrim, it is understood that embodiments of the invention are directed to multiaxial scrim, and that such process steps for producing a multiaxial scrim would be readily understood by those ordinarily skilled in the art reviewing the pending disclosure. In this regard, if a multiaxial scrim is to be produced, several fiber bands 6 with different directions relative to the direction of movement of transport chains 2 and 3 can be laid one on top of the other and the layers lying one on top of the other may then be fed to a bonding device, not shown in further detail.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A device for producing scrims of fiber bands comprising:
a dispensing arrangement structured and arranged for dispensing fiber bands;
a severing device structured and arranged for cutting the fiber bands to a cut length and comprising a knife with a cutting edge displaceable in a direction of an extension of the cutting edge;
a conveyor device structured and arranged for conveying at least one layer of fiber bands to a bonding device; and
a transport device structured and arranged to deposit the cut length fiber bands onto the conveyor device.

2. The device in accordance with claim 1, wherein the scrim comprises monoaxial or multiaxial scrims.

3. The device in accordance with claim 1, wherein the at least one layer of fiber bands comprises a plurality of the cut length fiber bands arranged next to one another.

4. The device in accordance with claim 1, wherein the cutting edge is arranged to run in a plane parallel to a surface of the fiber bands into which the cutting edge is structured and arranged to be plunged.

5. The device in accordance with claim 1, wherein relative movement between the knife and the fibers bands is coordinated so that the fiber bands are severable by a single movement of the cutting edge.

6. The device in accordance with claim 1, wherein the knife comprises a rotary knife band.

7. The device in accordance with claim 1, further comprising a mating profile assigned to the knife,
wherein the knife and the mating profile are movable relative to one another in a direction perpendicular to a cutting direction.

8. The device in accordance with claim 7, wherein the mating profile includes a groove into which the knife is structured and arranged to be plunged.

9. The device in accordance with claim 7, further comprising a dropper arranged on a same side of the conveyor as the mating profile, the dropper being structured and arranged to press the fiber band into a holding device of the conveyor device.

10. The device in accordance with claim 9, wherein the dropper and the mating profile are attached to a common holder.

11. The device in accordance with claim 10, wherein the dropper and the mating profile are arranged for relative movement via a spring arrangement.

12. The device in accordance with claim 1, further comprising a bearing surface is arranged on a same side of the dispensing arrangement as the knife.

13. The device in accordance with claim 12, wherein the bearing surface is an elastically yielding bearing surface.

14. A method for producing one of monoaxial or multiaxial scrims, comprising:
removing predetermined length of a fiber band with a dispensing arrangement;
guiding a cutting edge of a knife through the fiber band in a thickness direction with a dragging cut to sever the fiber band to a cut length;
placing the cut length fiber bands next to previously placed cut length fiber bands on a conveyor device; and
bonding the fiber bands placed next to one another.

15. The method in accordance with claim 14, wherein the dragging cut is performed with a movement in a single direction.

16. The method in accordance with claim 15, wherein the dragging cut is performed with an uninterrupted movement.

17. The method in accordance with claim 14, further comprising pressing the fiber band in a direction toward, the knife and at the same time pressing the fiber band onto a holding device on the conveyor device.

18. The method in accordance with claim 14, wherein the pressing of the fiber band toward the knife results in a compression of a thickness of the fiber band.

19. The method in accordance with claim 17, wherein the dragging cut is performed while the thickness of the fiber band is compressed.

20. A method for producing one of monoaxial or multiaxial scrims, comprising:
drawing predetermined lengths of fiber band from a fiber band supply;
simultaneously severing an entire width of the fiber band with a dragging cut to form fiber bands of a predetermined cut length;
successively placing the predetermined cut length fiber bands next to one another on a conveyor device; and
bonding the fiber bands placed next to one another.
